(19) United States
(12) Patent Application Publication
(10) Pub. No.: US 2019/0165372 A1
(43) Pub. Date: May 30, 2019

(54) POSITIVE ELECTRODE MATERIAL AND LITHIUM SECONDARY BATTERY USING THE SAME

(71) Applicants: TOYOTA JIDOSHA KABUSHIKI KAISHA, Toyota-shi (JP); SUMITOMO METAL MINING CO., LTD., Tokyo (JP)

(72) Inventors: Ryuta SUGIURA, Toyohashi-shi (JP); Taira AIDA, Niihama-shi (JP); Tetsutaro HAYASHI, Niihama-shi (JP); Satoshi KANADA, Niihama-shi (JP)

(73) Assignees: TOYOTA JIDOSHA KABUSHIKI KAISHA, Toyota-shi (JP); SUMITOMO METAL MINING CO., LTD., Tokyo (JP)

(21) Appl. No.: 16/196,017

(22) Filed: Nov. 20, 2018

(30) Foreign Application Priority Data
Nov. 28, 2017 (JP) 2017-228008

(51) Int. Cl. H01M 4/505; H01M 10/0525; H01M 4/525; H01M 4/62; H01M 4/36

(52) U.S. Cl. CPC H01M 4/505; H01M 10/0525; H01M 2004/028; H01M 4/624; H01M 4/366; H01M 4/525

(57) ABSTRACT

A positive electrode material for a lithium secondary battery, including: a positive electrode active material represented by Li_{1+α}NiₓCo_{y}Mn_{z}M^{I}ₜO₂ and having a layered rock salt-type crystal structure; an electron-conducting oxide represented by LaₚAe₁₋ₚCo_{q}M^{II}_{1-q}O_{3-δ}; and a Li ion-conducting oxide including Li element, 0 element, and at least one element selected from W, P, Nb, and Si.

### INCORPORATION BY REFERENCE

The disclosure of Japanese Patent Application No. 2017-228008 filed on Nov. 28, 2017 including the specification, drawings and abstract is incorporated herein by reference in its entirety.

### BACKGROUND

### 1. Technical Field

The disclosure relates to a positive electrode material and a lithium secondary battery using the same.

### 2. Description of Related Art

In an effort to improve the performance of lithium secondary batteries, increases in input-output density and in durability have been attempted. In this context, Japanese Patent Application Publication No. 2017-103058 and Japanese Patent Application Publication No. 2014-022204 each disclose a positive electrode material having a surface-treated positive electrode active material. For example, JP 2017-103058 A discloses a positive electrode material having positive electrode active material particles the surface of which is coated with a perovskite electron-conducting oxide (such as LaCoO₃). According to JP 2017-103058 A, the coating of the surface of the positive electrode active material particles with the electron-conducting oxide can lead to increase in the electron conductivity of the positive electrode and hence reduction in battery resistance.

### SUMMARY

However, the electron-conducting oxide has low Li ion conductivity. Thus, for the positive electrode material of JP 2017-103058 A, the coating of the positive electrode active material with the electron-conducting oxide may entail the disadvantage of impeding intercalation and deintercalation of Li ion into and from the surface of the positive electrode active material. Concerning batteries for use in which high-rate charge/discharge is repeated at a current of, for example, 2 C or higher, therefore, there is a demand for increasing not only the electron conductivity but also the Li ion conductivity to further reduce the battery resistance.

The present disclosure provides a positive electrode material having both high electron conductivity and high Li ion conductivity. The present disclosure also provides a lithium secondary battery with reduced resistance.

A first aspect of the present disclosure is a positive electrode material for a lithium secondary battery, the positive electrode material including the following components (1) to (3): (1) a positive electrode active material represented by Li_{1+α}NiₓCo_{y}Mn_{z}M^{I}ₜO₂ wherein −0.1≤α≤0.5, x+y+z+t=1, 0.3×0.9, 0≤y≤0.55, 0≤z≤0.55, 0≤t≤0.1 and, in the case of 0<t, M^{I} is at least one element selected from Mg, Ca, Al, Ti, V, Cr, Si, Y, Zr, Nb, Mo, Hf, Ta, and W, the positive electrode active material having a layered rock salt-type crystal structure; (2) an electron-conducting oxide represented by LaₚAe₁₋ₚCo_{q}M^{II}_{1-q}O_{3-δ} wherein 0<p≤1, 0<q<1 and, in the case of p<1, Ae is at least one alkaline earth metal element, M^{II} is at least one element selected from Mn and Ni, and δ is an oxygen deficiency level for achieving electrical neutrality; and (3) a Li ion-conducting oxide including Li element, O element, and at least one element selected from W, P, Nb, and Si.

The positive electrode material includes the component (1) and further includes the components (2) and (3). This enables the positive electrode material to have excellent electron conductivity and Li ion conductivity and exhibit synergetic effect of the components (2) and (3). Consequently, as indicated by test examples described later, the positive electrode material can offer a significant resistance reducing effect that is greater than an expected sum of the effect of the addition of the component (2) alone to the positive electrode active material and the effect of the addition of the component (3) alone to the positive electrode active material. The use of the positive electrode material composed as described above therefore makes it possible to obtain a lithium secondary battery having better battery characteristics (such as input-output characteristics and high-rate charge/discharge characteristics) than that obtained, for example, by the use of the positive electrode active material disclosed in JP 2017-103058 A.

In the first aspect, an amount of the electron-conducting oxide may be within a range of 0.05 parts by mass to 5 parts by mass per 100 parts by mass of the positive electrode active material. The amount of the electron-conducting oxide may be within a range of 0.2 parts by mass to 3 parts by mass per 100 parts by mass of the positive electrode active material. This can impart much better electron conductivity to the positive electrode material, thereby further improving the conduction path in a positive electrode. It is therefore possible to reduce the battery resistance more effectively and obtain the effect of the technology disclosed herein at a higher level.

In the first aspect, an amount of the Li ion-conducting oxide may be within a range of 0.05 parts by mass to 5 parts by mass per 100 parts by mass of the positive electrode active material. The amount of the Li ion-conducting oxide may be within a range of 0.2 parts by mass to 3 parts by mass per 100 parts by mass of the positive electrode active material. This increases the Li diffusivity in the positive electrode and thus enables smoother intercalation and deintercalation of Li into and from the surface of the positive electrode active material. It is therefore possible to reduce the battery resistance more effectively and obtain the effect of the technology disclosed herein at a higher level.

In the first aspect, the positive electrode active material may be in the form of particles, the Li ion-conducting oxide may be in the form of a film disposed on the surface of each of the particles, and the electron-conducting oxide may be in the form of particles. This enables the positive electrode material to have higher levels of both electron conductivity and Li ion conductivity.

In the first aspect, the Li ion-conducting oxide may be Li₂WO₄ or Li₃PO₄.

A second aspect of the present disclosure is a lithium secondary battery including the positive electrode material as defined above. Such a lithium secondary battery is, for example, a battery having a low initial resistance and having such good high-rate cycle characteristics that the battery experiences less decrease in battery capacity even when the battery undergoes repeated charge/discharge at a high rate of 2 C or more.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic longitudinal cross-sectional view of a lithium secondary battery according to one embodiment;

FIG. 2 is a graph comparing the battery resistance for Examples 1 to 9; and

FIG. 3 is a graph comparing the cycle capacity retention for Examples 1 to 9.

### DETAILED DESCRIPTION OF EMBODIMENTS

Hereinafter, a preferred embodiment of the present disclosure will be described. The matters that are other than the features particularly described herein (such as the composition and nature of the positive electrode material) and that are necessary for implementing the present disclosure can be understood as matters of design choice based on prior art for skilled persons (examples of the matters include other battery components not characterizing the present disclosure and common processes for producing batteries). The present disclosure can be implemented on the basis of the details disclosed herein and common general knowledge in the art. A numerical range “A to B” (A and B may be any numerical values) as described herein is defined as meaning “A or more and B or less”.

Positive Electrode Material

The positive electrode material as disclosed herein is a material for use in a positive electrode of a lithium secondary battery. The positive electrode material includes at least (1) a positive electrode active material, (2) an electron-conducting oxide, and (3) a Li ion-conducting oxide. These components will now be described.

(1) Positive Electrode Active Material

The positive electrode active material is a material capable of reversibly absorbing and releasing Li ions serving as a charge carrier. The positive electrode active material has a layered rock salt structure. The crystal structure of the positive electrode active material can be identified by X-ray diffraction (XRD) analysis.

The positive electrode active material includes a lithium transition metal composite oxide represented by the following formula (I): Li_{1+α}NiₓCo_{y}Mn_{z}M^{I}ₜO₂. In the formula (I), a, x, y, z, and t are real numbers satisfying the relationships −0.1≤α≤0.5, x+y+z+t=1, 0.3≤x≤0.9, 0≤y≤0.55, 0≤z≤0.55, and 0≤t≤0.1. In the case of 0<t, M^{I} is at least one element selected from Mg, Ca, Al, Ti, V, Cr, Si, Y, Zr, Nb, Mo, Hf, Ta, and W.

The lithium transition metal composite oxide represented by the formula (I) is a lithium-nickel-containing composite oxide containing Ni as an essential component. Specific examples of the lithium transition metal composite oxide represented by the formula (I) include a lithium-nickel-cobalt-containing composite oxide wherein 0<y, a lithium-nickel-manganese-containing composite oxide wherein 0<z, a lithium-nickel-cobalt-manganese-containing composite oxide wherein 0<y and 0<z, and a lithium-nickel-cobalt-aluminum-containing composite oxide wherein 0<y, 0<t, and M^{I} includes Al. It is preferable for the lithium transition metal composite oxide represented by the formula (I) to contain Co in addition to Ni.

In the case of 0<α, the lithium transition metal composite oxide represented by the formula (I) is a so-called lithium-excess lithium transition metal composite oxide. In the formula (I), x may be, for example, 0.4≤x≤0.8 or 0.8≤0.9. y may be, for example, 0.01≤y≤0.2, 0.07≤y≤0.15, 0.01≤y≤0.5, or 0.1≤y≤0.3. z may be 0.01≤z≤0.1, 0.03≤z≤0.05, 0.01≤z≤0.5, or 0.1≤z≤0.3.

The composition of the positive electrode active material can be identified, for example, by: (i) observing a cross-section of the positive electrode active material by scanning transmission electron microscopy (STEM) to obtain a STEM image and subjecting the STEM image to composition analysis by energy dispersive X-ray spectrometry (EDX) or electron energy loss spectroscopy (EELS); or (ii) subjecting the positive electrode active material to element analysis by inductively coupled plasma-optical emission spectrometry (ICP-OES) or by inductively coupled plasma-atomic emission spectrometry (ICP-AES). For (2) electron-conducting oxide and (3) Li ion-conducting oxide described later, the composition formula can be determined in the same manner.

The positive electrode active material is typically in the form of particles. The average particle size of the positive electrode active material is not particularly limited. From the viewpoint of handleability etc., it is recommended that the average particle size be generally 0.1 μm or more and typically 1 μm or more, for example 5 μm or more. In order to form a dense, homogeneous positive electrode, it is recommended that the average particle size be generally 30 μm or less and typically 20 μm or less, for example 10 μm or less. The term “average particle size” as used herein refers to a particle size at which the cumulative percent of volume of smaller-size particles is 50% in a volume-based particle size distribution obtained by particle size distribution measurement based on a laser diffraction-light scattering method.

(2) Electron-Conducting Oxide

The electron-conducting oxide has the function of improving the electron conductivity of the positive electrode active material. The electron-conducting oxide has a higher electron conductivity than the positive electrode active material and the Li ion-conducting oxide. The electron-conducting oxide preferably has a perovskite-type crystal structure. The perovskite-type electron-conducting oxide is highly adaptable to deformation of the positive electrode active material. This allows a good electron conduction path to be maintained between particles of the positive electrode active material even when, for example, the positive electrode active material undergoes repeated rapid swelling and shrinkage during high-rate charge/discharge cycles. The crystal structure of the electron-conducting oxide can be identified, for example, by: (i) observing the peak attributed to the electron-conducting oxide in XRD analysis; or (ii) observing an electron beam diffraction pattern in transmission electron microscopy (TEM).

The electron-conducting oxide includes a lanthanum-cobalt-containing oxide represented by the following formula (II): LaₚAe₁₋ₚCo_{q}M^{II}_{1-q}O_{3-δ}. In the formula (II), p and q are real numbers satisfying 0<p≤1 and 0<q<1. In the case of p<1, Ae is at least one element selected from alkaline earth metal elements and is, for example, at least one element selected from Ca, Sr, and Ba. M^{II} is Mn and/or Ni. δ is an oxygen deficiency level for achieving electrical neutrality and is, for example, −0.5≤δ≤0.5.

Specific examples of the lanthanum-cobalt-containing oxide represented by the formula (II) include a lanthanum-nickel-cobalt-containing oxide containing Ni as the element M^{II} and a lanthanum-nickel-cobalt-manganese-containing oxide containing Ni and Mn as the element M^{II}. The lanthanum-cobalt-containing oxide represented by the formula (II) preferably contains Ni as the element M^{II}. When the lithium transition metal composite oxide represented by the formula (I) contains Ni, Co, and Mn, the lanthanum-cobalt-containing oxide represented by the formula (II) preferably contains Mn and Ni as the element M^{II}. The lanthanum-cobalt-containing oxide represented by the formula (II) preferably contains an alkaline earth metal element (Ae). That is, in the formula (II), p is preferably p<1.

In the formula (II), p may be, for example, 0.2≤p or 0.5≤p. q may be, for example, 0.01≤q≤0.6 or 0.1≤q≤0.3. The use of the lanthanum-cobalt-containing oxide having such an elemental composition can further improve the electron conductivity of the positive electrode. This consequently reduces the battery resistance to a larger extent.

The lanthanum-cobalt-containing oxide has characteristics such that the electron conductivity of the lanthanum-cobalt-containing oxide increases as the temperature of the usage environment decreases within a common temperature range where batteries are used, such as a temperature range of −20 to 60° C. Such characteristics allow effective reduction in battery resistance in a range of low temperatures at which batteries are likely to have a high resistance. With the inclusion of the M^{II} element as an essential component in the lanthanum-cobalt-containing oxide, the crystal structure can be stably maintained in a high potential state and/or in a high temperature environment (at 60° C. or higher, for example).

The amount of the electron-conducting oxide added is not particularly limited. For example, it is recommended that per 100 parts by mass of the positive electrode active material, the amount of the electron-conducting oxide added be generally 0.001 to 10 parts by mass, typically 0.005 to 6 parts by mass, preferably 0.05 to 5 parts by mass, and more preferably 0.2 to 3 parts by mass. When the amount of the electron-conducting oxide added falls within the above range, the effect of the technology disclosed herein can be stably obtained at a higher level.

The amount of the electron-conducting oxide added can be determined, for example, by: (i) subjecting the positive electrode material to XRD analysis to obtain peaks attributed to the components and subjecting the peaks to Rietveld analysis; or (ii) making a calculation from element proportions obtained by ICP-OES or ICP-AES analysis. For (3) Li ion-conducting oxide described later, the amount added can be determined in the same manner.

(3) Li Ion-Conducting Oxide

The Li ion-conducting oxide has the function of improving the Li ion conductivity of the positive electrode active material. Preferably, the Li ion-conducting oxide has the function of assisting intercalation and deintercalation of Li ions into and from the surface of the positive electrode active material even when a film is formed on the surface of the positive electrode active material as a result of, for example, repeated charge/discharge cycles. More preferably, the Li ion-conducting oxide has the function of inhibiting dissolution of the constituent elements from the positive electrode active material to enhance the structural stability of the positive electrode active material. The Li ion-conducting oxide has a higher Li ion conductivity than the positive electrode active material and the electron-conducting oxide. The Li ion-conducting oxide includes a lithium oxide containing Li element, O element, and at least one element selected from W, P, Nb, and Si.

Specific examples of such a lithium oxide include lithium tungstate (such as LiWO₂, Li₂WO₄, Li₄WO₅, or Li₆W₂O₉), lithium phosphate (such as Li₃PO₄), lithium niobate (such as LiNbO₃ or LiNb₂O₅), and lithium silicate (such as Li₄SiO₄). The lithium oxide preferably contains W and/or P as a constituent element and particularly preferably contains W. In other words, the lithium oxide preferably includes a W-containing lithium oxide (such as lithium tungstate) and/or P-containing lithium oxide (such as lithium phosphate) and more preferably includes a W-containing lithium oxide. As indicated by test examples described later, the use of a lithium oxide having such an elemental composition can further improve the Li ion conductivity of the resulting positive electrode. This consequently reduces the battery resistance to a larger extent.

The amount of the Li ion-conducting oxide added is not particularly limited. For example, it is recommended that per 100 parts by mass of the positive electrode active material, the amount of the Li ion-conducting oxide added be generally 0.001 to 10 parts by mass, typically 0.005 to 6 parts by mass, preferably 0.05 to 5 parts by mass, and more preferably 0.2 to 3 parts by mass. When the amount of the Li ion-conducting oxide added falls within the above range, the effect of the technology disclosed herein can be stably obtained at a higher level. The mixing ratio between the electron-conducting oxide and Li ion-conducting oxide is not particularly limited, but it is recommended that the mixing ratio be generally 10:1 to 1:10, typically 2:1 to 1:2, and, for example, 1:1. With such a mixing ratio, the positive electrode can have a better balance of the electron conductivity and the Li ion conductivity.

As indicated by test examples described later, the manner in which the components (1) to (3) are arranged is not particularly limited. In an example, the positive electrode material is a mixture of the components (1) to (3). For example, each of the components (1) to (3) is in the form of particles distinct from the other components, and the particles of the components (1) to (3) are mixed to form the positive electrode material. In another example, the positive electrode material includes composite particles formed of a combination of two or more of the components (1) to (3). For example, the positive electrode material includes composite particles including the positive electrode active material in the form of particles and a film portion disposed on the surface of the positive electrode active material in the form of particles, the film portion containing at least one of the electron-conducting oxide and the Li ion-conducting oxide. Such composite particles can be produced, for example, by a liquid-phase method.

In a preferred embodiment, the positive electrode material includes the following particles (a) and (b): (a) composite particles including a positive electrode active material in the form of particles and a film portion disposed on the surface of the positive electrode active material in the form of particles, the film portion containing the Li ion-conducting oxide; and (b) the electron-conducting oxide in the form of particles. The particles (a) and (b) may be particles distinct from each other or may be combined together, for example, by co-baking. The structural feature of the particles (a) allows more smooth intercalation and deintercalation of Li into and from the surface of the positive electrode active material. The structural feature of the particles (b) can facilitate electron donation and withdrawal between the composite particles. With these features, therefore, the effect of the technology disclosed herein can be obtained at a high level to more effectively reduce the resistance of the positive electrode.

The respective forms of the electron-conducting oxide and the Li ion-conducting oxide, namely whether the electron-conducting oxide and the Li ion-conducting oxide are in the form of particles or a layer, can be confirmed, for example, by STEM. The details of the measurement method are described for test examples below. In the present specification, the electron-conducting oxide or Li ion-conducting oxide is determined to be in the form of “particles” in the case where the L/M value is 0.3≤(L/M)≤10 is satisfied for a portion at which the positive electrode active material and the electron-conducting oxide or Li ion-conducting oxide are in contact, where L denotes a contact distance over which the positive electrode active material and the electron-conducting oxide or Li ion-conducting oxide are in contact and M denotes a dimension of the electron-conducting oxide or Li ion-conducting oxide in a direction away from the positive electrode active material. In the case of (L/M)>10, the electron-conducting oxide or Li ion-conducting oxide is determined to be in the form of a “film”.

The positive electrode material may consist solely of the three components (1) to (3) described above or may further include an additive component as long as the effect of the technology disclosed herein is not significantly impaired. Examples of the additive component include conventionally known positive electrode active materials other than those of the formula (I) and conventionally known electron-conducting materials other than those of the formula (II).

As described above, the positive electrode material disclosed herein includes (1) a positive electrode active material and further includes (2) an electron-conducting oxide and (3) a Li ion-conducting oxide. This enables the positive electrode material to have both improved electron conductivity and improved ion conductivity and exhibit synergetic effect of the components (2) and (3). Consequently, a significant reduction in resistance of a positive electrode can be achieved. The use of the positive electrode material composed as described above therefore makes it possible to obtain a lithium secondary battery excellent, for example, in input-output characteristics.

Further, by virtue of the inclusion of (2) electron-conducting oxide, the positive electrode material allows effective maintenance of an electron conduction path in a positive electrode even when, for example, the positive electrode active material undergoes repeated rapid swelling and shrinkage during high-rate charge/discharge cycles. Additionally, by virtue of the inclusion of (3) Li ion-conducting oxide, the positive electrode material can exhibit improved mobility or diffusivity of Li ions in the vicinity of the surface of the positive electrode active material. This enables smooth intercalation and deintercalation of Li ions on and from the surface of the positive electrode active material even when a film is formed on the surface of the positive electrode active material as a result of, for example, repeated charge/discharge cycles. The use of the positive electrode material composed as described above therefore makes it possible to obtain a lithium secondary battery excellent, for example, in high-rate charge/discharge characteristics.

Positive Electrode for Lithium Secondary Battery

The positive electrode material disclosed herein is used in a positive electrode of a lithium secondary battery. The positive electrode of the lithium secondary battery typically includes a positive electrode current collector and a positive electrode active material layer formed on the positive electrode current collector and containing the positive electrode material. Examples of the positive electrode current collector include foils of metals such as aluminum. The positive electrode active material layer can, if necessary, contain optional components such as a conductive material, a binder, and a dispersant in addition to the positive electrode material. Examples of the conductive material include carbon materials such as carbon black. Examples of the binder include vinyl halide resins such as polyvinylidene fluoride (PVdF).

Lithium Secondary Battery

The positive electrode is used for construction of a lithium secondary battery. The lithium secondary battery includes the positive electrode, a negative electrode, and an electrolyte. The negative electrode is not particularly limited and may be a conventional one. The negative electrode typically includes a negative electrode current collector and a negative electrode active material layer formed on the negative electrode current collector. Examples of the negative electrode current collector include foils of metals such as copper. The negative electrode active material layer contains a negative electrode active material capable of reversibly absorbing and releasing a charge carrier. Preferred examples of the negative electrode active material include carbon materials such as graphite. The negative electrode active material layer may further contain optional components such as a binder and a thickener in addition to the negative electrode active material. Examples of the binder include vinyl halide resins such as polyvinylidene fluoride (PVdF). Examples of the thickener include carboxymethyl cellulose (CMC).

The electrolyte is not particularly limited. The electrolyte is typically a nonaqueous electrolyte containing a supporting salt and a nonaqueous solvent. The electrolyte is typically an electrolyte solution that is a liquid at room temperature (25° C.). The supporting salt dissociates to give Li ions as a charge carrier in the nonaqueous solvent. Examples of the supporting salt include fluorine-containing lithium salts such as LiPF₆ and LiBF₄. Examples of the nonaqueous solvent include aprotic solvents such as carbonates, esters, and ethers.

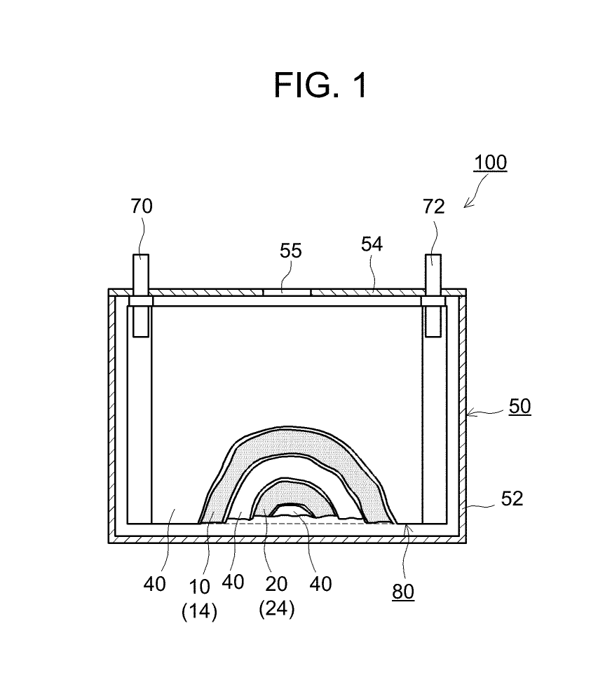

FIG. 1 is a schematic longitudinal cross-sectional view of a lithium secondary battery 100 according to an embodiment. The lithium secondary battery 100 includes a wound electrode assembly 80 of a flat shape, a non-illustrated nonaqueous electrolyte, and a battery case 50 having a flat, rectangular parallelepiped shape and containing the wound electrode assembly 80 and the nonaqueous electrolyte. The battery case 50 includes: a battery case body 52 having a flat, rectangular parallelepiped shape and having an open top side; and a cover 54 covering the opening of the top side. The material of the battery case 50 is, for example, a lightweight metal such as aluminum. The shape of the battery case is not particularly limited and is, for example, a rectangular parallelepiped shape or cylindrical shape. The top surface of the battery case 50, namely the cover 54, is provided with a positive electrode terminal 70 and a negative electrode terminal 72 for external connection. A part of each of the terminals 70 and 72 projects outwardly of the surface of the cover 54. The cover 54 is further provided with a safety vent 55 for discharging gas generated inside the battery case 50 to the outside of the battery case 50.

The wound electrode assembly 80 includes a strip-shaped positive electrode sheet 10 and a strip-shaped negative electrode sheet 20. The positive electrode sheet 10 includes a strip-shaped positive electrode current collector and a positive electrode active material layer 14 formed on the surface of the positive electrode current collector. The positive electrode active material layer 14 includes the positive electrode material disclosed herein. The negative electrode sheet 20 includes a strip-shaped negative electrode current collector and a negative electrode active material layer 24 formed on the surface of the negative electrode current collector. The positive electrode sheet 10 and the negative electrode sheet 20 are insulated from each other by a separator sheet 40. The material of the separator sheet 40 is, for example, a resin such as polyethylene (PE), polypropylene (PP), or polyester. The positive electrode sheet 10 is electrically connected to the positive electrode terminal 70. The negative electrode sheet 20 is electrically connected to the negative electrode terminal 72. The wound electrode assembly 80 of the present embodiment is of a flat shape. However, the wound electrode assembly 80 may be of any appropriate shape depending on, for example, the shape of the battery case or the intended use of the battery and may be, for example, of a cylindrical shape or in the form of a stack.

Applications of Lithium Secondary Battery

The lithium secondary battery 100 including the positive electrode material can be used in various applications and can, due to its input-out characteristics or high-rate cycle characteristics better than those of conventional products, be preferably used in applications where high-rate charge/discharge is to be repeated. Examples of such applications include a power source (a drive power supply) for a motor mounted in a vehicle. The type of the vehicle is not particularly limited, and typical examples of the vehicle include automobiles such as plug-in hybrid automobiles (PHV), hybrid automobiles (HV), and electric automobiles (EV). Typically, a plurality of the lithium secondary batteries 100 are used in the form of an assembled battery in which the lithium secondary batteries are connected in series and/or in parallel.

Hereinafter, several examples of the present disclosure will be described. The following description is not intended to limit the present disclosure to the examples.

### Examination I. Examination on Amount to be Added

### Comparative Example 1

A lithium-nickel-cobalt-manganese composite oxide (layered rock salt structure, LiNi_{0.4}Co_{0.3}Mn_{0.3}O₂) in the form of particles having an average particle size of 10 μm was prepared and used by itself as a positive electrode material.

### Comparative Examples 2 and 3

First, a positive electrode active material identical to that of Comparative Example 1 was prepared. Next, the prepared positive electrode active material and LaNi_{0.4}Co_{0.3}Mn_{0.3}O₃ as an electron-conducting oxide were mixed, and the mixture was heat-treated at 400° C. for 5 hours. The mixing ratio between the positive electrode active material and the electron-conducting oxide was controlled so that the amount of the electron-conducting oxide added was 0.05 parts by mass (Comparative Example 2) or 0.1 parts by mass (Comparative Example 3) per 100 parts by mass of the positive electrode active material. The electron-conducting oxide in the form of particles was thus attached to the surface of the positive electrode active material in the form of particles, and the resulting material was used as a positive electrode material.

### Comparative Examples 4 and 5

First, a positive electrode active material identical to that of Comparative Example 1 was prepared. Next, the prepared positive electrode active material and Li₂WO₄ as a Li ion-conducting oxide were mixed, and the mixture was heat-treated at 400° C. for 5 hours. The mixing ratio between the positive electrode active material and the Li ion-conducting oxide was controlled so that the amount of the Li ion-conducting oxide added was 0.05 parts by mass (Comparative Example 4) or 0.1 parts by mass (Comparative Example 5) per 100 parts by mass of the positive electrode active material. The Li ion-conducting oxide in the form of particles was thus attached to the surface of the positive electrode active material in the form of particles, and the resulting material was used as a positive electrode material.

### Examples 1 to 9

First, a positive electrode active material identical to that of Comparative Example 1 was prepared. Next, the prepared positive electrode active material, LaNi_{0.4}Co_{0.3}Mn_{0.3}O₃ as an electron-conducting oxide, and Li₂WO₄ as a Li ion-conducting oxide were mixed, and the mixture was heat-treated (co-baked) at 400° C. for 5 hours. The mixing ratio among the positive electrode active material, the electron-conducting oxide, and the Li ion-conducting oxide was controlled so that the amounts of the electron-conducting oxide added and the Li ion-conducting oxide added were each 0.005 to 6 parts by mass per 100 parts by mass of the positive electrode active material. Both the electron-conducting oxide in the form of particles and the Li ion-conducting oxide in the form of particles were thus attached to the surface of the positive electrode active material in the form of particles, and the resulting material was used as a positive electrode material.

Evaluation of Battery Characteristics

Construction of Lithium Secondary Battery

A lithium secondary battery was constructed using a positive electrode material obtained as above. Specifically, first, the positive electrode material, acetylene black (AB) as a conductive material, and polyvinylidene fluoride (PVdF) as a binder were weighed so that the solids mass ratio among the positive electrode active material in the positive electrode material, AB, and PVdF, as expressed by positive electrode active material:AB:PVdF would be 84:12:4. A planetary mixer was used to mix these materials together in N-methyl-2-pyrrolidone (NMP) to give a solids content of 50% by mass. A positive electrode slurry was thus prepared. This positive electrode slurry was applied to both surfaces of a strip-shaped aluminum foil (positive electrode current collector) using a die coater and dried. The dried positive electrode slurry was then pressed together with the aluminum foil. In this manner, a strip-shaped positive electrode sheet including a positive electrode current collector and a positive electrode active material layer provided on the positive electrode current collector was produced.

Next, a strip-shaped negative electrode sheet was prepared that included a negative electrode current collector and a negative electrode active material layer containing graphite as a negative electrode active material and provided on both surfaces of the negative electrode current collector. Next, the strip-shaped positive electrode sheet produced as above and the strip-shaped negative electrode sheet prepared were opposed across a strip-shaped separator sheet, and these sheets were wound in their longitudinal direction to produce a wound electrode assembly. Current-collecting members were then welded respectively to the positive electrode sheet and the negative electrode sheet. Next, ethylene carbonate (EC), dimethyl carbonate (DMC), and ethyl methyl carbonate (EMC) were mixed in a volume ratio of 3:4:3 to prepare a mixed solvent. LiPF₆ as a supporting salt was dissolved in this mixed solvent at a concentration of 1.1 mol/L to prepare a nonaqueous electrolyte solution. The wound electrode assembly and the nonaqueous electrolyte solution were then placed in a battery case, and subsequently the battery case was sealed. In this manner, lithium secondary batteries each containing one of the various positive electrode materials were constructed.

Activation Treatment

Each lithium secondary battery produced as above was subjected to activation treatment. Specifically, in an environment at a temperature of 25° C., constant current (CC) charge was carried out at a rate of ⅓ C until a voltage of 4.2 V was reached, and subsequently constant voltage (CV) charge was carried out until a current of 1/50 C was reached. The lithium secondary battery was thus fully charged. Next, constant current (CC) discharge was carried out at a rate of ⅓ C until a voltage of 3 V was reached. Herein, “1C” refers to a current value at which a battery can be charged in 1 hour to a battery capacity (Ah) estimated from the theoretical capacity of the active materials.

Measurement of Battery Resistance

The lithium secondary battery subjected to the activation treatment was adjusted to a voltage of 3.70 V (corresponding to a SOC of 56%) in an environment at a temperature of 25° C. Next, in an environment at a temperature of 25° C., CC discharge was carried out at a discharge rate of 10 C until a voltage of 3.00 V was reached. The voltage change (ΔV) during 5 seconds from the start of discharge was divided by the discharge current value to calculate the battery resistance. The results are shown in Table 1. The values shown in Table 1 are those normalized based on the battery resistance (100) of a lithium secondary battery according to Comparative Example 1.

Measurement of High-Rate Cycle Characteristics

The lithium secondary battery subjected to the activation treatment was placed in a thermostatic chamber at 60° C. to stabilize the temperature of the battery. In an environment at a temperature of 60° C., the battery was subjected to 500 charge/discharge cycles each consisting of carrying out CC charge at a rate of 2 C until a voltage of 4.2 V was reached and then carrying out CC discharge at a rate of 2 C until a voltage of 3.0 V was reached. The CC discharge capacity at the 500-th cycle was divided by the CC discharge capacity at the first cycle to calculate the cycle capacity retention (%). The results are shown in Table 1.

TABLE 1

| | | Electron-conducting oxide | | Li ion-conducting oxide | | | |
|---|---|---|---|---|---|---|---|
| | Positive electrode | | Amount | | Amount | Battery | Cycle |
| | active material | | added | | added | resistance | capacity |
| | Composition | Composition | (parts by | Composition | (parts by | (relative | retention |
| | formula | formula | mass) | formula | mass) | value) | (%) |
| Comparative | LiNi_{0.4}Co_{0.3}Mn_{0.3}O₂ | — | 0 | — | 0 | 100 | 60 |
| Example 1 | | | | | | | |
| Comparative | LiNi_{0.4}Co_{0.3}Mn_{0.3}O₂ | LaNi_{0.4}Co_{0.3}Mn_{0.3}O₃ | 0.05 | — | 0 | 94 | 62 |
| Example 2 | | | | | | | |
| Comparative | LiNi_{0.4}Co_{0.3}Mn_{0.3}O₂ | LaNi_{0.4}Co_{0.3}Mn_{0.3}O₃ | 0.1 | — | 0 | 92 | 65 |
| Example 3 | | | | | | | |
| Comparative | LiNi_{0.4}Co_{0.3}Mn_{0.3}O₂ | — | 0 | Li₂WO₄ | 0.05 | 96 | 62 |
| Example 4 | | | | | | | |
| Comparative | LiNi_{0.4}Co_{0.3}Mn_{0.3}O₂ | — | 0 | Li₂WO₄ | 0.1 | 94 | 65 |
| Example 5 | | | | | | | |
| Example 1 | LiNi_{0.4}Co_{0.3}Mn_{0.3}O₂ | LaNi_{0.4}Co_{0.3}Mn_{0.3}O₃ | 0.005 | Li₂WO₄ | 0.005 | 91 | 71 |
| Example 2 | LiNi_{0.4}Co_{0.3}Mn_{0.3}O₂ | LaNi_{0.4}Co_{0.3}Mn_{0.3}O₃ | 0.03 | Li₂WO₄ | 0.03 | 89 | 73 |
| Example 3 | LiNi_{0.4}Co_{0.3}Mn_{0.3}O₂ | LaNi_{0.4}Co_{0.3}Mn_{0.3}O₃ | 0.05 | Li₂WO₄ | 0.05 | 70 | 80 |
| Example 4 | LiNi_{0.4}Co_{0.3}Mn_{0.3}O₂ | LaNi_{0.4}Co_{0.3}Mn_{0.3}O₃ | 0.15 | Li₂WO₄ | 0.15 | 69 | 81 |
| Example 5 | LiNi_{0.4}Co_{0.3}Mn_{0.3}O₂ | LaNi_{0.4}Co_{0.3}Mn_{0.3}O₃ | 0.2 | Li₂WO₄ | 0.2 | 59 | 88 |
| Example 6 | LiNi_{0.4}Co_{0.3}Mn_{0.3}O₂ | LaNi_{0.4}Co_{0.3}Mn_{0.3}O₃ | 0.5 | Li₂WO₄ | 0.5 | 60 | 90 |
| Example 7 | LiNi_{0.4}Co_{0.3}Mn_{0.3}O₂ | LaNi_{0.4}Co_{0.3}Mn_{0.3}O₃ | 3 | Li₂WO₄ | 3 | 61 | 89 |
| Example 8 | LiNi_{0.4}Co_{0.3}Mn_{0.3}O₂ | LaNi_{0.4}Co_{0.3}Mn_{0.3}O₃ | 5 | Li₂WO₄ | 5 | 71 | 80 |
| Example 9 | LiNi_{0.4}Co_{0.3}Mn_{0.3}O₂ | LaNi_{0.4}Co_{0.3}Mn_{0.3}O₃ | 6 | Li₂WO₄ | 6 | 90 | 71 |

As seen from Table 1, Comparative Examples 2 and 3 where the positive electrode material contained an electron-conducting oxide and Comparative Examples 4 and 5 where the positive electrode material contained a Li ion-conducting oxide showed a slight reduction in battery resistance and a slight improvement in cycle capacity retention as compared to Comparative Example 1 where only a positive electrode active material was used as the positive electrode material. However, the effects were very limited; for example, the improvement in cycle capacity retention was 5% at most.

In contrast to Comparative Examples, Examples 1 to 9 where the positive electrode material contained both an electron-conducting oxide and a Li ion-conducting oxide explicitly exhibited the effect on reduction in battery resistance and the effect on improvement in cycle capacity retention. By way of example, Comparative Examples 2 and 4 and Example 3 are compared. In Comparative Example 2 where only an electron-conducting oxide was added in an amount of 0.05 parts by mass, the reduction in battery resistance was only 6%, and in Comparative Example 4 where only a Li ion-conducting oxide was added in an amount of 0.05 parts by mass, the reduction in battery resistance was only 4%. By contrast, in Example 3 where an electron-conducting oxide and a Li ion-conducting oxide were each added in an amount of 0.05 parts by mass, the battery resistance was surprisingly reduced by 30%. Further, the improvement in cycle capacity retention was only 2% in both Comparative Example 2 and Comparative Example 4. By contrast, in Example 3, the cycle capacity retention was surprisingly improved by 20%. This result demonstrates the significance of the technology disclosed herein.

Although it remains to be clarified why the coexistence of an electron-conducting oxide and a Li ion-conducting oxide offers a considerably high effect, the present inventors hypothesize that the inclusion of an electron-conducting oxide and a Li ion-conducting oxide in a positive electrode material leads to establishment of a new mechanism like so-called polaron conduction, in which electrons and Li ions interact with each other to be conducted in the positive electrode.

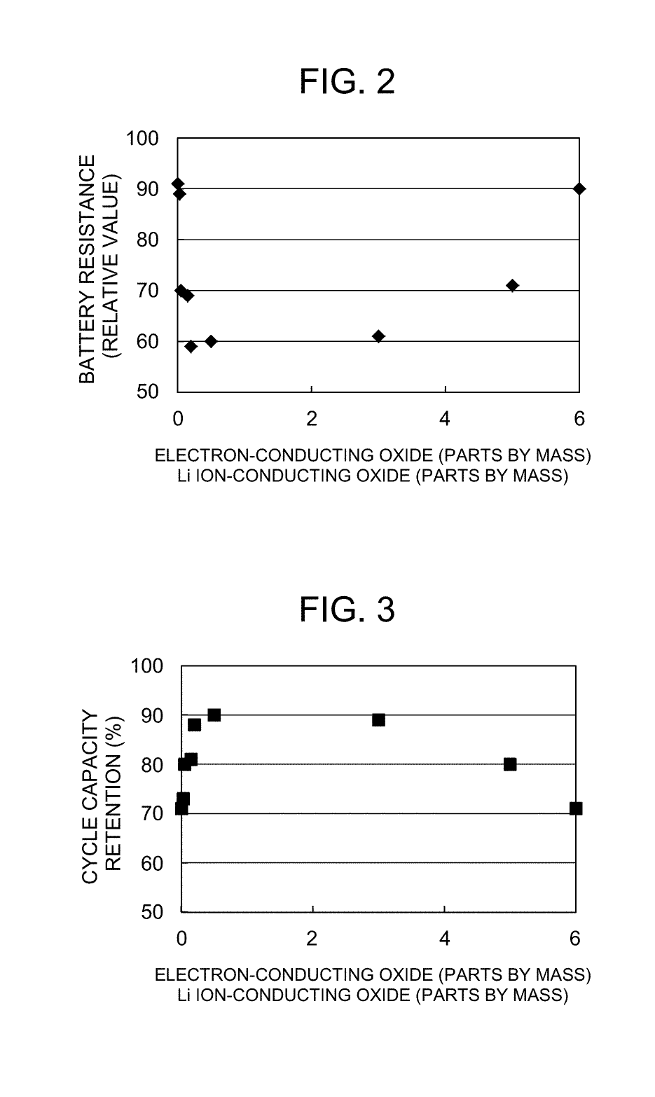

FIG. 2 is a graph comparing the battery resistance for Examples 1 to 9. FIG. 3 is a graph comparing the cycle capacity retention for Examples 1 to 9. As seen from FIGS. 2 and 3, comparison of Examples 1 to 9 reveals that Examples 3 to 8 where an electron-conducting oxide and a Li ion-conducting oxide were each added in an amount of 0.05 to 5 parts by mass exhibited the effect on reduction in battery resistance and the effect on improvement in cycle capacity retention at higher levels. In particular, Examples 5 to 7 where an electron-conducting oxide and a Li ion-conducting oxide were each added in an amount of 0.2 to 3 parts by mass exhibited the effect on reduction in battery resistance and the effect on improvement in cycle capacity retention at considerably higher levels. This demonstrated that the amount of the electron-conducting oxide added is preferably controlled to 0.05 to 5 parts by mass, more preferably 0.2 to 3 parts by mass, per 100 parts by mass of the positive electrode active material. It was also found that the amount of the Li ion-conducting oxide added is preferably controlled to 0.05 to 5 parts by mass, more preferably 0.2 to 3 parts by mass, per 100 parts by mass of the positive electrode active material.

### Examination II. Examination on Type of Li Ion-Conducting Oxide

### Examples 10 to 12 and Comparative Example 6

Positive electrode materials were used that were the same as that used in Examples 3, except that Li₃PO₄ (Example 10), LiNbO₃ (Example 11), Li₄SiO₄ (Example 12), or Li₅La₃Zr₂O₁₂ (Comparative Example 6) was used as the Li ion-conducting oxide instead of Li₂WO₄. The battery characteristics were evaluated in the same manner as in Examination I. The results are shown in Table 2.

TABLE 2

| | | Electron-conducting oxide | | Li ion-conducting oxide | | | |
|---|---|---|---|---|---|---|---|
| | Positive electrode | | Amount | | Amount | Battery | Cycle |
| | active material | | added | | added | resistance | capacity |
| | Composition | Composition | (parts by | Composition | (parts by | (relative | retention |
| | formula | formula | mass) | formula | mass) | value) | (%) |
| Example 10 | LiNi_{0.4}Co_{0.3}Mn_{0.3}O₂ | LaNi_{0.4}Co_{0.3}Mn_{0.3}O₃ | 0.05 | Li₃PO₄ | 0.05 | 71 | 79 |
| Example 11 | LiNi_{0.4}Co_{0.3}Mn_{0.3}O₂ | LaNi_{0.4}Co_{0.3}Mn_{0.3}O₃ | 0.05 | LiNbO₃ | 0.05 | 78 | 71 |
| Example 12 | LiNi_{0.4}Co_{0.3}Mn_{0.3}O₂ | LaNi_{0.4}Co_{0.3}Mn_{0.3}O₃ | 0.05 | Li₄SiO₄ | 0.05 | 80 | 72 |
| Comparative | LiNi_{0.4}Co_{0.3}Mn_{0.3}O₂ | LaNi_{0.4}Co_{0.3}Mn_{0.3}O₃ | 0.05 | Li₅La₃Zr₂O₁₂ | 0.05 | 98 | 56 |
| Example 6 | | | | | | | |

As seen from Table 2, the battery resistance in Comparative Example 6 employing Li₅La₃Zr₂O₁₂ was comparable to the battery resistance in Comparative Example 1 employing only a positive electrode active material as the positive electrode material. The cycle capacity retention in Comparative Example 6 was lower than that in Comparative Example 1. By contrast, in Examples 10 to 12 employing Li₃PO₄, LiNbO₃, or Li₄SiO₄ as the Li ion-conducting oxide showed the effect on reduction in battery resistance and the effect on improvement in cycle capacity retention as compared to Comparative Example 1.

Comparison of Examples 3 and 10 to 12 reveals that Example 3 employing Li₂WO₄ as the Li ion-conducting oxide and Example 10 employing Li₃PO₄ as the Li ion-conducting oxide exhibited the effect on reduction in battery resistance and the effect on improvement in cycle capacity retention at higher levels. In particular, Example 3 employing Li₂WO₄ as the Li ion-conducting oxide exhibited the effect on reduction in battery resistance and the effect on improvement in cycle capacity retention at considerably higher levels. This demonstrated that it is preferable to use a W-containing lithium oxide and/or a P-containing lithium oxide as the Li ion-conducting oxide and that it is particularly preferable to use lithium tungstate as the Li ion-conducting oxide.

### Examination III. Examination on Types of Positive Electrode Active Material and Electron-Conducting Oxide

### Examples 13 to 20

Positive electrode materials were used that were the same as that used in Example 3, except that the type of the positive electrode active material and the type of the electron-conducting oxide were changed as shown in Table 3. The battery characteristics were evaluated in the same manner as in Examination I. The results are shown in Table 3.

TABLE 3

| | | Electron-conducting oxide | | Li ion-conducting oxide | | | |
|---|---|---|---|---|---|---|---|
| | Positive electrode | | Amount | | Amount | Battery | Cycle |
| | active material | | added | | added | resistance | capacity |
| | Composition | Composition | (parts by | Composition | (parts by | (relative | retention |
| | formula | formula | mass) | formula | mass) | value) | (%) |
| Example 13 | LiNi_{0.5}Co_{0.2}Mn_{0.3}O₂ | LaNi_{0.5}Co_{0.2}Mn_{0.3}O₃ | 0.05 | Li₂WO₄ | 0.05 | 72 | 80 |
| Example 14 | LiNi_{0.6}Co_{0.2}Mn_{0.2}O₂ | LaNi_{0.6}Co_{0.2}Mn_{0.2}O₃ | 0.05 | Li₂WO₄ | 0.05 | 75 | 76 |
| Example 15 | LiNi_{0.8}Co_{0.1}Mn_{0.1}O₂ | LaNi_{0.8}Co_{0.1}Mn_{0.1}O₃ | 0.05 | Li₂WO₄ | 0.05 | 77 | 71 |
| Example 16 | LiNi_{0.8}Co_{0.15}Al_{0.05}O₂ | LaNi_{0.8}Co_{0.2}O₃ | 0.05 | Li₂WO₄ | 0.05 | 75 | 84 |
| Example 17 | LiNi_{0.9}Co_{0.07}Al_{0.03}O₂ | LaNi_{0.9}Co_{0.1}O₃ | 0.05 | Li₂WO₄ | 0.05 | 77 | 76 |
| Example 18 | LiNi_{0.9}Co_{0.07}Al_{0.03}O₂ | La_{0.5}Ca_{0.5}Ni_{0.4}Co_{0.3}Mn_{0.3}O₃ | 0.05 | Li₂WO₄ | 0.05 | 58 | 90 |
| Example 19 | LiNi_{0.9}Co_{0.07}Al_{0.03}O₂ | La_{0.5}Ba_{0.5}Ni_{0.4}Co_{0.3}Mn_{0.3}O₃ | 0.05 | Li₂WO₄ | 0.05 | 61 | 87 |
| Example 20 | LiNi_{0.9}Co_{0.07}Al_{0.03}O₂ | La_{0.5}Sr_{0.5}Ni_{0.4}Co_{0.3}Mn_{0.3}O₃ | 0.05 | Li₂WO₄ | 0.05 | 60 | 89 |

The results shown in Table 3 for Examples 13 to 20 demonstrated that the effect of the technology disclosed herein can be sufficiently obtained even when the composition of the positive electrode active material is varied, as long as the composition of the positive electrode active material satisfies the formula (I). It was also found that the effect of the technology disclosed herein can be sufficiently obtained even when the composition of the electron-conducting oxide is varied, as long as the composition of the electron-conducting oxide satisfies the formula (II). In particular, Examples 18 to 20 employing an electron-conducting oxide containing an alkaline earth metal element (Ae) exhibited the effect on reduction in battery resistance and the effect on improvement in cycle capacity retention at higher levels, for example, than Example 17 employing an electron-conducting oxide not containing Ae. This demonstrated that the formula (II) representing the electron-conducting oxide preferably contains an alkaline earth metal element (Ae).

### Examination IV. Examination of Forms of Components

### Examples 21 to 23

In Example 21, a composite material was produced that included a positive electrode active material in the form of particles and a film portion formed on the surface of the positive electrode active material, the film portion containing an electron-conducting oxide and a Li ion-conducting oxide. This composite material was used as a positive electrode material. Specifically, first, the electron-conducting oxide was attached in the form of a film to the surface of the positive electrode active material in the form of particles. More specifically, first, a sulfuric acid salt of lanthanum, a sulfuric acid salt of nickel, a sulfuric acid salt of cobalt, and a sulfuric acid salt of manganese were weighed so that the molar ratio among the metal elements, as expressed by La:Ni:Co:Mn, would be 1.0:0.4:0.3:0.3, and an aqueous solution containing these metal elements was prepared. Next, the positive electrode active material in the form of particles was added to the prepared aqueous solution, which was then stirred. The mixing ratio between the positive electrode active material and the electron-conducting oxide was controlled so that the amount of the electron-conducting oxide added would be 0.07 parts by mass per 100 parts by mass of the positive electrode active material. Next, the aqueous solution was heated to 60° C. for removal of the solvent, followed by heat treatment at 450° C. for 5 hours. In this manner, the electron-conducting oxide was attached in the form of a layer to the surface of the positive electrode active material in the form of particles. Next, a Li ion-conducting oxide was attached in the form of a film to the surface of the positive electrode active material in the form of particles. Specifically, first, the Li ion-conducting oxide in the form of particles were dissolved in pH-adjusted water, and then the positive electrode active material in the form of particles were mixed in a predetermined proportion with the resulting solution to prepare a composition in the form of a slurry. Next, this composition was stirred at ordinary temperature (25° C.) for 30 minutes and then dried by heat treatment at 150° C. In this manner, the Li ion-conducting oxide was attached in the form of a film to the surface of the positive electrode active material to which the electron-conducting oxide had been attached. The resulting material was used as a positive electrode material.

In Example 22, a composite material was produced that included a positive electrode active material in the form of particles and a film portion formed on the surface of the positive electrode active material, the film portion containing no electron-conducting oxide but a Li ion-conducting oxide. Specifically, the Li ion-conducting oxide was attached in the form of a film to the surface of the positive electrode active material in the form of particles in the same manner as in Example 21. Next, as in Example 3, the positive electrode active material with the Li ion-conducting oxide attached thereto and the electron-conducting oxide in the form of particles were mixed, and the mixture was heat-treated. In this manner, the electron-conducting oxide in the form of particles were attached to the surface of the positive electrode active material to which the Li ion-conducting oxide had been attached. The resulting material was used as a positive electrode material.

In Example 23, a composite material was produced that included a positive electrode active material in the form of particles and a film portion formed on the surface of the positive electrode active material, the film portion containing no Li ion-conducting oxide but an electron-conducting oxide. Specifically, the electron-conducting oxide was attached in the form of a film to the surface of the positive electrode active material in the form of particles in the same manner as in Example 21. Next, as in Example 3, the positive electrode active material with the electron-conducting oxide attached thereto and the Li ion-conducting oxide in the form of particles were mixed, and the mixture was heat-treated. In this manner, the Li ion-conducting oxide was attached in the form of a particle to the surface of the positive electrode active material to which the electron-conducting oxide had been attached. The resulting material was used as a positive electrode material. The battery characteristics were evaluated in the same manner as in Examination I. The results are shown in Table 4.

Determination of Forms of Electron-Conducting Oxide and Li Ion-Conducting Oxide

A cross-section of each of the positive electrode materials of Examples 3 and 21 to 23 was observed by STEM to determine the forms of the electron-conducting oxide and Li ion-conducting oxide, namely whether these oxides were in the form of particles or a film. Specifically, first, the positive electrode material was embedded and polished to expose a cross-section. Next, the cross-section of the positive electrode material was observed by STEM to obtain a bright-field image or a STEM-HAADF (high-angle-annular-dark-field) image at such a magnification that the particles constituting the positive electrode material were seen in their entirety in the image. Next, the bright-field image or the STEM-HAADF image was used to perform element mapping to identify the positive electrode active material, the electron-conducting oxide, and the Li ion-conducting oxide. Next, in the outer periphery of the positive electrode active material, a portion that was in contact with the electron-conducting oxide was selected, and the contact distance L over which the positive electrode active material and the electron-conducting oxide were in contact along the outer periphery of the positive electrode active material and the dimension (thickness) M of the electron-conducting oxide in a direction away from the outer periphery were measured. It should be noted that the units of L and M were the same. L was divided by M to calculate a L/M value. This measurement was performed at N=10 for each positive electrode material, and an arithmetic mean of the L/M values was determined. For the Li ion-conducting oxide, L/M values were calculated in the same manner. The results are shown in Table 4. In Table 4, “Particles” in the column headed “Form” represents the case where the L/M value was 0.3≤(L/M)≤10, while “Film” in the column headed “Form” represents the case where the L/M value was (L/M)>10.

TABLE 4

| | | Electron-conducting oxide | | | | Li ion-conducting oxide | | | | Battery | Cycle |
|---|---|---|---|---|---|---|---|---|---|---|---|
| | Positive electrode | | Amount | | | | Amount | | | resis- | capacity |
| | active material | | added | | | | added | | | tance | reten- |
| | Composition | Composition | (parts by | | | Composition | (parts by | | | (relative | tion |
| | formula | formula | mass) | Form | L/M | formula | mass) | Form | L/M | value) | (%) |
| Exam- | LiNi_{0.4}Co_{0.3}Mn_{0.3}O₂ | LaNi_{0.4}Co_{0.3}Mn_{0.3}O₃ | 0.07 | Particles | 1 | Li₂WO₄ | 0.07 | Particles | 1 | 70 | 80 |
| ple 3 | | | | | | | | | | | |
| Exam- | LiNi_{0.4}Co_{0.3}Mn_{0.3}O₂ | LaNi_{0.4}Co_{0.3}Mn_{0.3}O₃ | 0.07 | Film | 50 | Li₂WO₄ | 0.07 | Film | 50 | 72 | 83 |
| ple 21 | | | | | | | | | | | |
| Exam- | LiNi_{0.4}Co_{0.3}Mn_{0.3}O₂ | LaNi_{0.4}Co_{0.3}Mn_{0.3}O₃ | 0.07 | Particles | 1 | Li₂WO₄ | 0.07 | Film | 50 | 69 | 91 |
| ple 22 | | | | | | | | | | | |
| Exam- | LiNi_{0.4}Co_{0.3}Mn_{0.3}O₂ | LaNi_{0.4}Co_{0.3}Mn_{0.3}O₃ | 0.07 | Film | 50 | Li₂WO₄ | 0.07 | Particles | 1 | 71 | 78 |
| ple 23 | | | | | | | | | | | |

As seen from Table 4, comparison of Examples 3 and 21 to 23 reveals that the effect of the technology disclosed herein can be sufficiently obtained even when the forms of the components in the positive electrode material are varied. In particular, Example 22, where the Li ion-conducting oxide was in the form of a film and the electron-conducting oxide was in the form of particles, exhibited the effect on reduction in battery resistance and the effect on improvement in cycle capacity retention at considerably high levels. This demonstrated that the Li ion-conducting oxide is preferably disposed as a film portion on the surface of the positive electrode active material. In other words, it was demonstrated that, for example, the Li ion-conducting oxide preferably covers the surface of the positive electrode active material and is located closer to the positive electrode active material than the electron-conducting oxide. It was also demonstrated that the electron-conducting oxide is preferably contained in the form of particles in the positive electrode material. In other words, it was demonstrated that the electron-conducting oxide is preferably located farther from the positive electrode active material than the Li ion-conducting oxide and has less contact with the positive electrode active material than the Li ion-conducting oxide.

Although the present disclosure has been described above in detail, the embodiments and examples described above are only illustrative, and the disclosure disclosed herein encompasses various variants and modifications of the specific examples described above.

What is claimed is:

1. A positive electrode material for a lithium secondary battery, comprising:
a positive electrode active material represented by Li_{1+α}NiₓCo_{y}Mn_{z}M^{I}ₜO₂ and having a layered rock salt-type crystal structure, wherein a, x, y, z, and t satisfy −0.1≤α≤0.5, x+y+z+t=1, 0.3≤x≤0.9, 0≤y≤0.55, 0≤z≤0.55, and 0≤t≤0.1 and, in a case of 0<t, M^{I} is at least one element selected from Mg, Ca, Al, Ti, V, Cr, Si, Y, Zr, Nb, Mo, Hf, Ta, and W;
an electron-conducting oxide represented by LaₚAe₁₋ₚCo_{q}M^{II}_{1-q}O_{3-δ} wherein p and q satisfy 0<p≤1 and 0<q<1 and, in a case of p<1, Ae is at least one element selected from alkaline earth metal elements, M^{II} is at least one element selected from Mn and Ni, and δ is an oxygen deficiency level for achieving electrical neutrality; and
a Li ion-conducting oxide including Li element, O element, and at least one element selected from W, P, Nb, and Si.

2. The positive electrode material according to claim 1, wherein an amount of the electron-conducting oxide is within a range of 0.05 parts by mass to 5 parts by mass per 100 parts by mass of the positive electrode active material.

3. The positive electrode material according to claim 1, wherein an amount of the electron-conducting oxide is within a range of 0.2 parts by mass to 3 parts by mass per 100 parts by mass of the positive electrode active material.

4. The positive electrode material according to claim 1, wherein an amount of the Li ion-conducting oxide is within a range of 0.05 parts by mass to 5 parts by mass per 100 parts by mass of the positive electrode active material.

5. The positive electrode material according to claim 1, wherein an amount of the Li ion-conducting oxide is within a range of 0.2 parts by mass to 3 parts by mass per 100 parts by mass of the positive electrode active material.

6. The positive electrode material according to claim 1, wherein the positive electrode active material is in a form of particles, the Li ion-conducting oxide is in a form of a film disposed on a surface of each of the particles, and the electron-conducting oxide is in a form of particles.

7. The positive electrode material according to claim 1, wherein the Li ion-conducting oxide is Li₂WO₄ or Li₃PO₄.

8. A lithium secondary battery comprising the positive electrode material according to claim 1.
